(19) United States
(12) Patent Application Publication
(10) Pub. No.: US 2026/0045042 A1
(43) Pub. Date: Feb. 12, 2026

(54) SYSTEM AND METHOD FOR DYNAMIC GENERATION AND RENDERING OF THREEDIMENSIONAL OBJECTS FROM TWO-DIMENSIONAL IMAGES

(71) Applicant: artlabs US Inc., Dover, DE (US)

(72) Inventors: Seyedmahdi Kazempourradi, Dubai (AE); Dogancan Kebude, Valencia (ES); Sercan Demircan, Barcelona (ES); Ugur Yekta Basak, Los Angeles, CA (US)

(21) Appl. No.: 19/296,507

(22) Filed: Aug. 11, 2025

Related U.S. Application Data
(60) Provisional application No. 63/681,935, filed on Aug. 12, 2024.

(51) Int. Cl. G06T 17/20; G06T 7/194; G06T 7/70; G06T 9/00; G06V 10/44; G06V 10/80

(52) U.S. Cl. CPC G06T 17/20; G06T 7/194; G06T 7/70; G06T 9/001; G06V 10/44; G06V 10/806; G06T 2207/30244

(57) ABSTRACT

A computer-implemented process for creating 3D objects from 2D images includes receiving an input image, conditioning a generative model using image-derived, voxelized three-dimensional features, generating, by a transformer-based rectified-flow generative model parameterized as a base network optionally coupled to one or more low-rank adapter modules activatable at inference, a volumetric latent of the target object, the volumetric latent including a sparse, feature-augmented volumetric lattice obtained by transporting an initial random sample toward a learned manifold via a rectified-flow sampling process, decoding the volumetric latent by mapping the volumetric latent to a feature-bearing sparse volumetric field consistent with the volumetric lattice, decoding the field to a continuous implicit surface function, and extracting a watertight mesh by isosurface extraction, estimating camera-pose parameters by render-and-compare alignment between silhouettes rendered from the mesh and silhouettes of the input image, and, performing style-preserving inverse rendering on the mesh that updates UV-space albedo and material maps.

### CROSS-REFERENCE TO RELATED APPLICATIONS

This patent applications claims priority to provisional application No. 63/681,935 filed Aug. 12, 2024 and titled System and Method for Dynamic Generation and Rendering of Three-Dimensional Objects from Two-Dimensional Images. The subject matter of provisional application No. 63/681,935 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to the field of digital image processing and, more specifically, the claimed subject matter relates to the field of methods and processes for creating three-dimensional (3D) objects from two-dimensional (2D) images.

### BACKGROUND

The task of generating three-dimensional (3D) models from two-dimensional (2D) images has garnered substantial interest across fields such as digital content creation, e-commerce, virtual and augmented reality, and industrial design. Advances in machine learning and computer vision have enabled automated pipelines that attempt to reconstruct 3D geometry and texture from one or more 2D views. While notable progress has been made, significant limitations remain in the capabilities and usability of existing systems.

Many current approaches rely on dense, multi-view supervision or assume controlled capture environments with known camera parameters and uniform lighting. In practical settings, such assumptions often do not hold. When only a few uncontrolled images are available, current systems tend to produce degraded outputs-both in geometric fidelity and texture consistency. These sparse-view conditions often lead to 3D reconstructions that appear visually plausible but exhibit incorrect shapes, distorted surface features, or inconsistencies across views. As a result, manual correction, retouching, or even full reshoots may be required to obtain usable assets.

Another key limitation lies in the flexibility and output constraints of existing systems. Many methods produce intermediate volumetric or point cloud representations that are not directly compatible with common downstream pipelines, especially in industries requiring watertight meshes, standard format support (e.g., glTF, USD), and physically based rendering (PBR) materials. Additionally, the ability to adjust triangle count, file size, or texture resolution is often lacking, making it difficult to tailor the outputs to application-specific requirements such as mobile deployment, real-time rendering, or 3D printing.

Although deep learning-based methods have achieved impressive results in generating high-quality 3D content, they often incur high computational costs during inference. In some cases, the models require repeated optimization loops or test-time fine-tuning, resulting in latency and scalability challenges, particularly in real-time or high-throughput environments. Furthermore, retraining from scratch is often required to adapt models to new domains or datasets, limiting operational flexibility. Finally, existing pipelines frequently entangle geometry estimation with camera pose inference, which can introduce geometric artifacts or instability if pose predictions are inaccurate. Decoupling these steps is non-trivial, and errors in one component can propagate to others, compounding inaccuracies in the final 3D reconstruction.

Therefore, what is needed is a system and method for improving the problems with the prior art, and more particularly for a more expedient and efficient method and system for creating 3D objects from 2D images.

### BRIEF SUMMARY

A computer-implemented process for creating 3D objects from 2D images that addresses the problems with the prior art, is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope

In one embodiment, a computer-implemented process for creating 3D objects from 2D images includes the steps of receiving at least one input image, conditioning a generative model using image-derived, voxelized three-dimensional features, generating, by a transformer-based rectified-flow generative model parameterized as a base network optionally coupled to one or more low-rank adapter modules activatable at inference, a volumetric latent of the target object, the volumetric latent comprising a sparse, feature-augmented volumetric lattice obtained by transporting an initial random sample toward a learned manifold via a rectified-flow sampling process, decoding the volumetric latent by mapping the volumetric latent to a feature-bearing sparse volumetric field consistent with said volumetric lattice, decoding the field to a continuous implicit surface function, and extracting a watertight mesh by isosurface extraction, estimating camera-pose parameters by iterative render-and-compare alignment between silhouettes rendered from the mesh and silhouettes of the at least one input image, and, performing style-preserving inverse rendering on the mesh that updates UV-space albedo and material maps while keeping mesh geometry and the estimated camera-pose parameters fixed, wherein the method performs images-only inference without reliance on natural-language prompts.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a system for executing a computer-implemented process for creating 3D objects from 2D images over a communications network, in accordance with one embodiment.

FIG. 2 is a block diagram showing the data flow of the computer-implemented process for creating 3D objects from 2D images over a communications network, according to one embodiment.

FIG. 3 is a flow chart depicting the general control flow of the computer-implemented process for creating 3D objects from 2D images over a communications network, according to one embodiment.

FIG. 4 is a block diagram depicting a system including an example computing device and other computing devices.

FIG. 5 is a diagram depicting an aspect of the process for creating 3D objects from 2D images over a communications network, according to one embodiment.

FIG. 6 is a diagram depicting another aspect of the process for creating 3D objects from 2D images over a communications network, according to one embodiment.

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The disclosed embodiments improve upon the problems with the prior art by addressing the challenges of computational load, accuracy, scalability, and flexibility in generating 3D models from 2D images. Utilizing advanced machine learning techniques and innovative image processing methods, the disclosed embodiments dynamically optimize camera positions and iteratively refine 3D models, eliminating the reliance on predefined viewpoints and enhancing accuracy. This process, implemented by the computing infrastructure of server 102 and/or computing device 131, introduces a number of technical improvements over conventional approaches. Notably, the disclosed embodiments eliminate the need for predefined camera positions, decouple camera pose estimation from mesh generation, remove reliance on natural language prompts, replace radiance field and splat-based intermediates with direct volumetric latents and mesh-only decoding, and support real-time inference via efficient conditional rectified flow sampling. Furthermore, the disclosed embodiments employ a curated dataset of 3D exemplars with quality control protocols and standardized metadata for training supervision, which improves geometric stability and scalability across varying domains and input conditions.

The claimed embodiments provide a robust, efficient, and scalable solution for producing realistic and interactive 3D content.

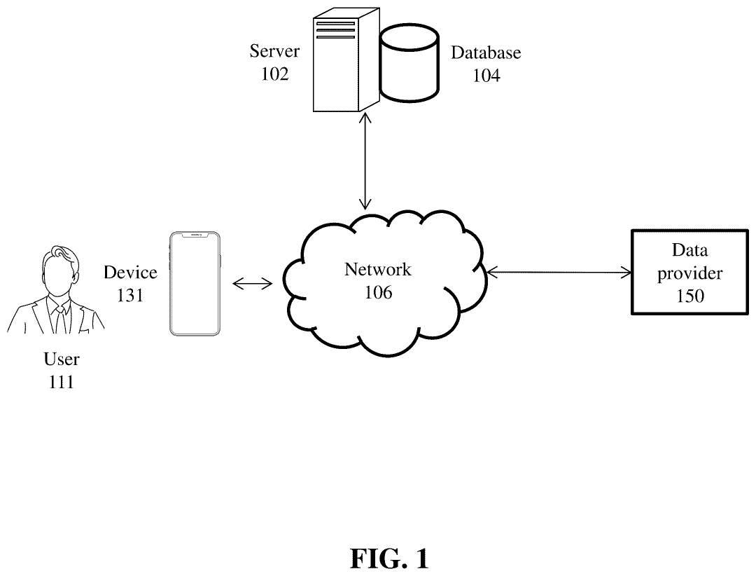

Referring now to the drawing figures in which like reference designators refer to like elements, there is shown in FIG. 1 an illustration of a block diagram showing the network architecture of a system 100 and method for creating 3D objects from 2D images in accordance with one embodiment. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating the process for creating 3D objects from 2D images.

FIG. 1 includes computing devices 131 and 102, which may be smart phones, mobile phones, tablet computers, handheld computers, laptops, or the like. In another embodiment, computing devices 131 and 102 may be workstations, desktop computers, servers, laptops, all-in-one computers, or the like. In another embodiment, computing devices 131, 102 may be AR or VR systems that may include display screens, headsets, heads up displays, helmet mounted display screens, or the like. Computing device 131 corresponds to a user 111 of the claimed embodiments. Devices 131 and 102 may be communicatively coupled with network 106 in a wired or wireless fashion.

FIG. 1 further shows that server 102 includes a database or repository 104, which may be a relational database comprising a Structured Query Language (SQL) database stored in a SQL server. Device 131 may also include its own database. The repository 104 serves data from a database, which is a repository for data used by server 102 and device 131 during the course of operation of the disclosed embodiments. Database 104 may be distributed over one or more nodes or locations that are connected via network 106.

The database 104 may include a user record for each user 111. A user record may include: contact/identifying information for the user (name, address, telephone number(s), email address, etc.), information pertaining to 2D reference images and 3D objects associated with the user, information pertaining to 3D models of the user, etc. A user record may also include a unique identifier for each user. A user record may further include demographic data for each user, such as age, sex, income data, race, color, marital status, etc.

The database 104 may include 2D reference images utilized by each user, as well as 3D objects and 3D models utilized or generated by each user. The database 104 may also include a configuration file comprising resolution parameters for training and evaluation, default camera settings including elevation and azimuth angles, and data requirements including depth and normal maps.

FIG. 1 shows an embodiment wherein networked computing device 131 interacts with server 102 and repository 104 over the network 106. It should be noted that although FIG. 1 shows only the networked computers 131 and 102, the system of the disclosed embodiments supports any number of networked computing devices connected via network 106. Further, server 102, and unit 131 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as device 131. Further, server 102 and its functionality, according to a preferred embodiment, can be realized in a centralized fashion in one computer system or in a distributed fashion wherein different elements are spread across several interconnected computer systems.

FIG. 1 also shows a data provider 150 connected to network 106. The data provider 150 represents an entity that provides data that is used by the claimed embodiments, such as 2D reference images. The data provider 150 may also represent the information technology infrastructure, including servers and computers, which are used by the data provider 150.

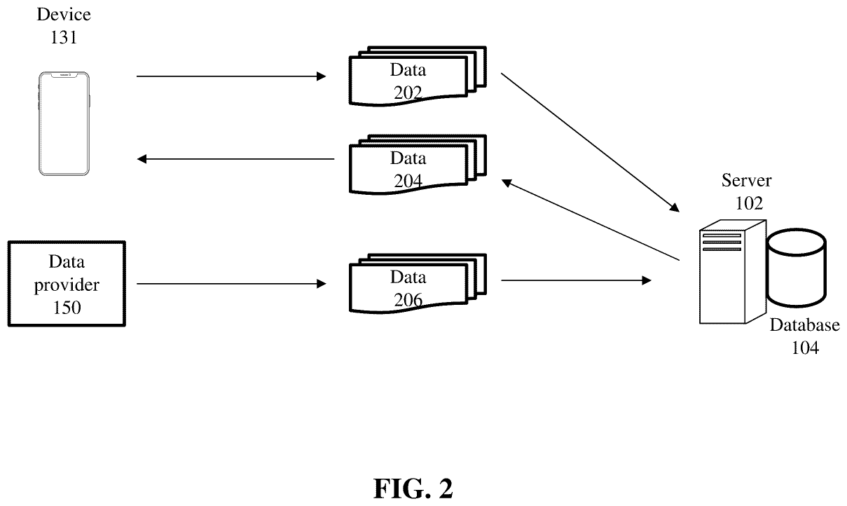

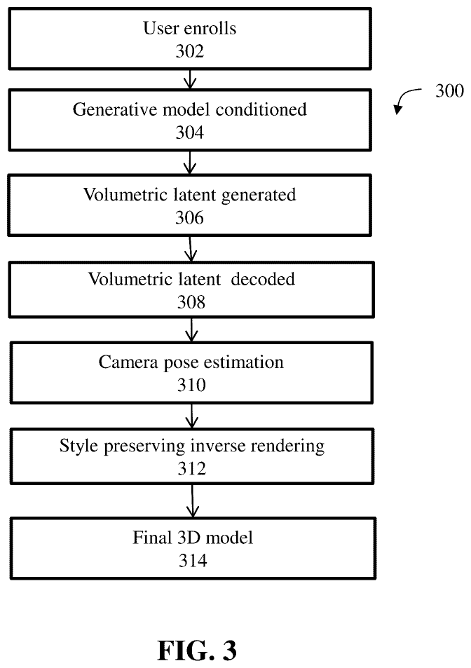

The process of generating a textured, watertight three-dimensional (3D) mesh from at least one two-dimensional (2D) input image over a communications network 106 will now be described in further detail with reference to FIGS. 2 and 3. This process, implemented by the computing infrastructure of server 102 and/or computing device 131, introduces a number of technical improvements over conventional approaches. Notably, the disclosed embodiments eliminate the need for predefined camera positions, decouple camera pose estimation from mesh generation, remove reliance on natural language prompts, replace radiance field and splat-based intermediates with direct volumetric latents and mesh-only decoding, and support real-time inference via efficient conditional rectified flow sampling. Furthermore, the system employs a curated dataset of 3D exemplars with quality control protocols and standardized metadata for training supervision, which improves geometric stability and scalability across varying domains and input conditions.

In step 302, and prior to inference, the user 111 may optionally register or enroll with the system via computing device 131. During this process, the user may upload or identify reference 2D images 202, either directly from device 131 or through access to an external data provider 150 (images 206). These images form the basis for subsequent model inference and are associated with the user's record in database 104, which also stores metadata, past outputs, and related training configurations.

In step 304, the system conditions a generative model using voxelized 3D features derived from the 2D image(s). These voxelized features are produced by extracting per-view embeddings using a frozen self-supervised transformer vision backbone. When multiple images are available, the system performs geometric projection and multi-view fusion using known or inferred camera intrinsics and extrinsics to produce a sparse voxel representation. The voxelized feature structure is arranged into either a sparse octree or sparse grid format and serialized in space-filling curve order (e.g., Morton code), with positional embeddings added to support downstream attention operations. This conditioning step initializes the latent representation from which the 3D object will be generated.

In step 306, the system generates a volumetric latent of the target object using a transformer-based rectified flow generative model. This model is parameterized as a base network that may optionally be coupled to one or more low rank adapter modules, which can be selectively activated or merged at inference time based on a domain profile. The rectified flow model operates by learning a time-conditioned vector field via conditional flow matching—a training objective that aligns vector field trajectories with the conditional data distribution. At inference, the model transports an initial random sample toward a learned data manifold using a fixed number of sampling steps, resulting in a sparse, feature-augmented volumetric lattice. This volumetric latent forms the foundational representation of the 3D object, incorporating structural and semantic information in a format optimized for sparse decoding.

In step 308, the system decodes the volumetric latent into a 3D surface representation using a three-stage process that avoids reliance on radiance fields or intermediate point clouds. First, the volumetric latent is mapped to a feature-bearing sparse volumetric field that preserves its lattice alignment and embedded features. Second, this field is decoded into a continuous implicit surface function, such as a signed distance function (SDF), which defines the object surface as the zero level set of a scalar field over a three-dimensional vector space. Training signals for this decoder may include silhouette consistency, surface normal alignment, smoothness regularization, and photometric losses from shaded render comparisons. Third, the implicit surface is converted into a polygonal mesh using an isosurface extraction algorithm (e.g., marching cubes), resulting in a watertight mesh suitable for downstream use in rendering engines or augmented reality systems.

Once the 3D mesh is available, step 310 initiates camera pose estimation. Rather than requiring predefined or externally calibrated camera positions, the system estimates camera pose parameters through an iterative render-and-compare alignment process. This alignment is performed between binary silhouettes rendered from the mesh and silhouette masks extracted from the input 2D images. When available, auxiliary signals such as monocular depth or surface normal estimates may be incorporated to stabilize the alignment. This post-mesh estimation method improves robustness to occlusions and noisy inputs while avoiding the geometric instabilities of pre-mesh pose estimation.

In step 312, the system performs a style-preserving inverse rendering step that updates UV-space albedo and material maps (e.g., normal, roughness, and metalness), without altering the mesh geometry or the estimated camera pose. This step is performed using differentiable rendering and registration-aware warping between reference images and differentiable renders of the mesh. The inverse rendering produces physically-based rendering (PBR) ready textures that are consistent across viewpoints and preserve the visual identity of the subject object, thereby supporting high-fidelity outputs suitable for commercial, gaming, and creative applications. Notably, all inference steps described above operate on images alone, without reliance on natural language prompts or caption-based conditioning. The result of step 312 is a 3D representation 204 of the target object is prepared in step 314.

Process 300 leverages a curated training dataset of 3D exemplars, which are normalized to a canonical coordinate frame and unit scale. Each exemplar is rendered using deterministic camera schedules with known intrinsics and extrinsics to produce multi-modal supervision, including RGB, linearized depth, surface normals, and silhouettes. Dataset entries are validated via automated quality control gates that reject samples with silhouette inconsistency, normal instability, or scale anomalies. Metadata for each entry includes a category taxonomy, license identifier, cryptographic content hash, and versioning information, ensuring dataset provenance, reproducibility, and domain-specific inference capabilities. These dataset characteristics support the training of dual rectified flow models: a structure flow model that transports noise to structure latents from voxel inputs and a latent flow model that outputs the final volumetric latent decoded into a mesh. The use of low rank adapter modules further enables efficient continual learning and domain adaptation without full retraining.

The claimed embodiments distinguish over prior art approaches, such as those dependent on autodecoding diffusion, radiance field generation, or prompt-based control. The use of conditional rectified flow models with structured volumetric decoding, combined with post-mesh pose estimation and PBR texture generation via image-only inverse rendering, delivers a scalable, efficient, and geometrically stable solution to 3D model reconstruction from 2D imagery. Outputs are compatible with standard interchange formats (e.g., glTF/GLB, USD/USDZ), making the system deployable across commercial and industrial workflows.

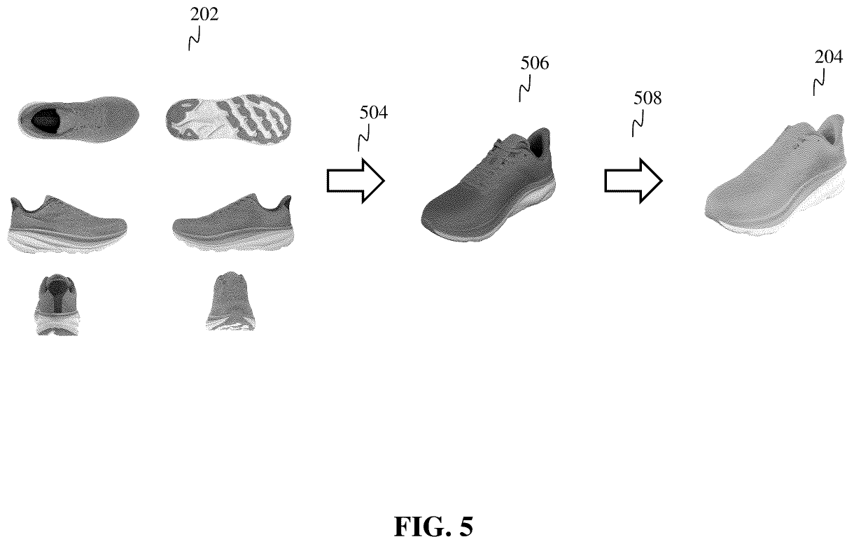

FIG. 5 is a diagram depicting an aspect of the process for creating 3D objects from 2D images over a communications network, according to one embodiment. FIG. 5 shows the generative products of the claimed embodiments, throughout the process. FIG. 5 shows input 2D images 202 which are processed by the images-to-mesh step 5504 wherein the images-only inference is conditioned on image-derived, voxelized 3D features. A transformer-based rectified-flow model produces a volumetric latent that is decoded to a watertight mesh. This results in an intermediate result 506 which is then processed by a texture refinement step 508 wherein after render-and-compare pose estimation is executed on silhouettes, and style-preserving inverse rendering updates UV-space while geometry and pose remain fixed. The final result is a textured mesh 204.

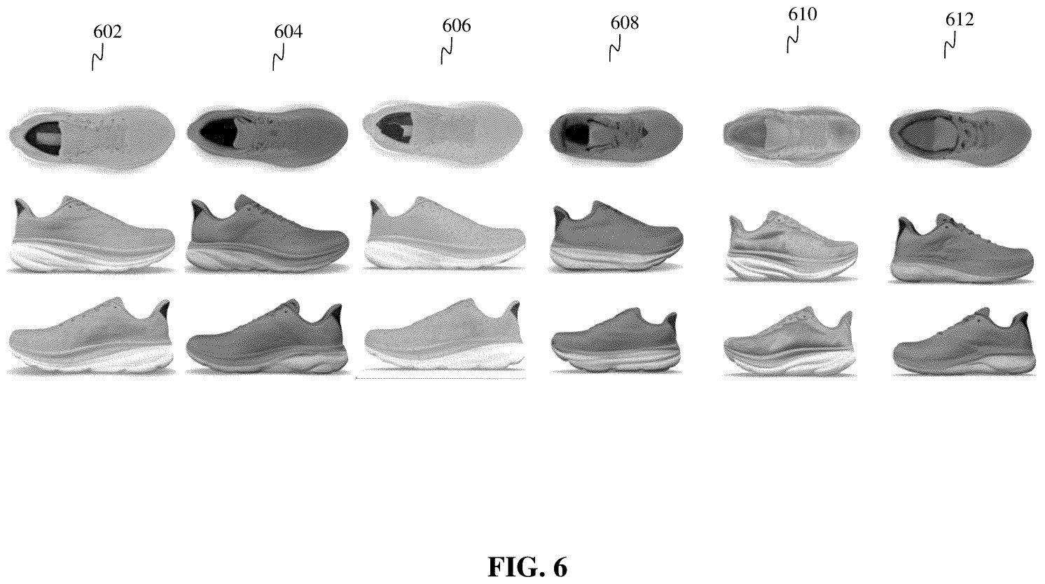

FIG. 6 is a diagram depicting another aspect of the process for creating 3D objects from 2D images over a communications network, according to one embodiment. FIG. 6 shows the generative products of the claimed embodiments, as compared to competing systems.

Column 602 shows original ground truth 3D scans that act as reference assets used to visually assess geometry and texture. Column 604 shows an intermediate result showing mesh only decoding wherein a volumetric latent is decoded to a watertight mesh by isosurface extraction. Low-rank adapter modules are activated at inference. Column 606 shows a final result of a textured mesh after iterative render-and-compare alignment on silhouettes to estimate camera-pose parameters, and style-preserving inverse rendering updates UV-space.

Columns 608, 610, and 612 display representative lower-quality outputs generated by a commercial system, included for comparative purposes. These examples illustrate the relative deficiencies in mesh shape and texture fidelity when compared to the results shown in columns 602-606.

The following definitions are provided to facilitate understanding of the technical terms used in the present disclosure. These terms are to be interpreted in a manner consistent with the specification and claims, and are not intended to limit the scope of the claimed invention unless expressly recited therein. In the context of generative modeling and machine learning, the term rectified flow refers to a generative scheme in which a model learns a time-conditioned vector field that transports an initial random sample toward a data manifold. This vector field is learned through a training process known as conditional flow matching, and sample generation at inference is performed by numerically integrating the field. A time-conditioned vector field is a function denoted v(x, t|c), where x is the current state, t is a scalar representing time or noise magnitude, and c is a conditioning signal (e.g., derived image features). The vector field outputs a velocity that directs the state x toward the target distribution when integrated over time.

Conditional flow matching is the training objective used to learn such vector fields. It involves fitting the vector field so that its integral curves match the distribution of data samples conditioned on specific signals, such as embeddings derived from input images. A transformer-based generative model is a neural generator architecture that relies on attention mechanisms for processing. The model consumes input embeddings and produces outputs by passing information through stacked layers of multi-head attention and feed-forward computations.

Low rank adapter modules refer to parameter-efficient augmentation layers that factor a weight update as a product of two low-rank matrices (ΔW=AB). These modules can be selectively activated or merged at inference to adapt the base model to specific domains without requiring full retraining. Embeddings are numerical vector representations provided to the model. These may include feature embeddings extracted from 2D images (often placed in voxel grids), and positional embeddings that encode spatial coordinates or serialized order, which support attention operations.

Query, key, and value projection matrices are the linear transformations used in transformer attention layers to convert inputs into components used for calculating attention weights and resulting context vectors. The learned manifold or data manifold refers to the low-dimensional subset of the model's high-dimensional output space that corresponds to valid or realistic samples. The generative process is designed to move initial samples toward this manifold.

With respect to 3D spatial structures, a voxel is a discrete volumetric element representing a cell in three-dimensional space. Voxelized three-dimensional features are embeddings or descriptors that are assigned to active voxels derived from 2D image projections.

A sparse voxel representation is a memory-efficient form of voxel storage that records only occupied or active voxels and their associated feature values, omitting empty regions. A sparse octree is a hierarchical spatial data structure that subdivides 3D space adaptively, storing finer resolution data only where necessary. A sparse grid, by contrast, is a flat, non-hierarchical mapping from voxel indices to values, used when spatial locality can be managed more simply.

A space-filling curve order is a deterministic method for serializing multi-dimensional voxel coordinates into a one-dimensional sequence that approximately preserves spatial locality. Examples include Morton (Z-order) curves. The volumetric latent is the primary latent representation generated by the model. It consists of a sparse, feature-augmented volumetric lattice aligned to 3D coordinates and used as input for downstream decoding stages.

A sparse, feature-augmented volumetric lattice is a 3D lattice in which only active cells are stored and each cell contains one or more learned feature channels. This structure enables efficient processing and accurate reconstruction. The feature-bearing sparse volumetric field is the decoded output of the volumetric latent. It retains sparsity and per-cell feature information and is used for surface reconstruction in the form of an implicit function.

A continuous implicit surface function is a scalar field f(x) defined over 3D vector space such that the surface of an object is represented by the level set f(x)=0. A commonly used form is the signed distance function (SDF), where the value of f(x) represents the signed distance to the nearest surface-negative values indicating interior regions and positive values indicating exterior regions. Isosurface extraction refers to techniques such as marching cubes that convert a continuous implicit function into a polygonal mesh by extracting the zero level set as a triangulated surface.

A watertight mesh is a polygonal 3D surface that forms a closed two-manifold without holes or gaps, suitable for use in rendering engines and 3D applications. UV space refers to a two-dimensional parameterization of a mesh surface used for storing texture maps. UV space maps include albedo (base color), normal (micro surface orientation), roughness (surface reflectivity variance), and metalness (whether a surface is conductive or dielectric). In terms of camera geometry and image alignment, camera intrinsics are parameters that define the internal characteristics of a camera, such as focal length, principal point, and lens distortion. Camera extrinsics describe the camera's position and orientation in world or object coordinates, comprising rotation and translation.

Camera pose parameters collectively refer to the extrinsic transformation (rotation and translation) used to render or interpret the mesh relative to the original 2D camera viewpoint. Geometric projection involves mapping 2D image-derived features into 3D space (e.g., voxels) using the camera intrinsics and extrinsics. When multiple views are available, multi-view fusion aggregates features from all views into a unified 3D representation. Foreground segmentation or silhouette masks involve identifying and isolating the object of interest from the background in 2D images, resulting in a binary contour used for alignment and training supervision. A silhouette refers to such a binary outline viewed from a specific angle. Monocular depth and surface normal estimates are auxiliary signals derived from a single image, representing per-pixel approximations of 3D depth and surface orientation, respectively.

Iterative render-and-compare alignment is a camera pose refinement procedure. It renders the current mesh and adjusts pose estimates by minimizing discrepancies between rendered silhouettes and observed image silhouettes. Differentiable rendering enables gradients of image-space loss functions (e.g., pixel intensity differences) to be propagated back to underlying scene parameters such as textures, supporting optimization in inverse rendering tasks.

Registration-aware warping refers to computing pixel correspondences between reference images and rendered views of the mesh to facilitate accurate texture updates during inverse rendering. Style-preserving inverse rendering is an optimization procedure that adjusts UV-space material maps to better match the appearance of input images while preserving the mesh geometry and camera pose. This allows the system to maintain identity and stylistic consistency in the rendered outputs. Finally, in the context of training and supervision, a curated dataset of three-dimensional exemplars refers to a maintained collection of 3D assets used to provide consistent training supervision for the model. Each exemplar is normalized to a canonical coordinate frame and unit scale, ensuring uniform orientation and size.

Deterministic camera schedules define fixed viewing trajectories with known intrinsics and extrinsics, used to render multi-modal supervision signals such as RGB, linearized depth, surface normals, and silhouettes. Multi-modal supervision improves training fidelity and geometric consistency. Linearized depth is a depth signal transformed such that pixel intensity is proportional to real-world metric distance, reducing nonlinear distortions due to perspective projection.

Quality control gates are automated tests that remove problematic dataset entries—such as those with inconsistent silhouettes, unstable normals, or scale outliers-from the training set. Each dataset entry may also include a cryptographic content hash (e.g., SHA-256) to ensure reproducibility, as well as metadata such as category taxonomy and licensing information. Per-view features are features extracted from each input image independently before being projected or fused into the voxelized representation.

Structured latent targets-also referred to as volumetric latents-are the intermediate representations used to train the generator and decoder models. These are in the form of sparse, feature-augmented volumetric lattices. Noisy voxel inputs are voxelized features perturbed with synthetic noise during training to improve the robustness of the rectified flow model. These are used in training the structure latents, which represent the intermediate latent variables learned by a first rectified flow model prior to final mesh decoding. Known camera models refer to calibrated camera intrinsics and extrinsics used during dataset generation to ensure consistency between rendered supervision and training targets.

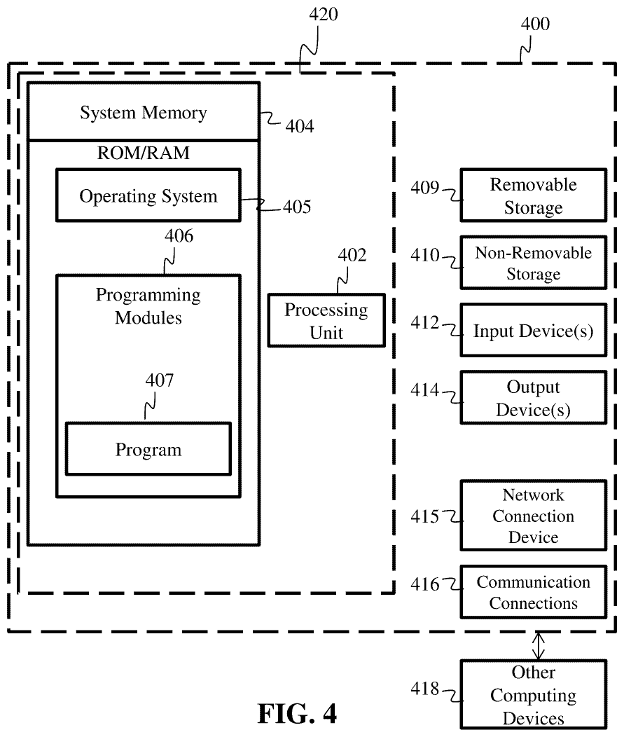

FIG. 4 is a block diagram of a system including an example computing device 400 and other computing devices. Consistent with the embodiments described herein, the aforementioned actions performed by 131, 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404.

Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of units 131, 102. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method of producing a three-dimensional digital representation of a target object from at least one two-dimensional input image, the method comprising:
(a) receiving the at least one input image;
(b) conditioning a generative model using image-derived, voxelized three-dimensional features;
(c) generating, by a transformer-based rectified-flow generative model parameterized as a base network optionally coupled to one or more low-rank adapter modules activatable at inference, a volumetric latent of the target object, the volumetric latent comprising a sparse, feature-augmented volumetric lattice obtained by transporting an initial random sample toward a learned manifold via a rectified-flow sampling process;
(d) decoding the volumetric latent by:
(1) mapping the volumetric latent to a feature-bearing sparse volumetric field consistent with said volumetric lattice;
(2) decoding the field to a continuous implicit surface function; and
(3) extracting a watertight mesh by isosurface extraction;
(e) estimating camera-pose parameters by iterative render-and-compare alignment between silhouettes rendered from the mesh and silhouettes of the at least one input image; and
(f) performing style-preserving inverse rendering on the mesh that updates UV-space albedo and material maps while keeping mesh geometry and the estimated camera-pose parameters fixed, wherein the method performs images-only inference without reliance on natural-language prompts.

2. The method of claim 1, wherein the image-derived, voxelized three-dimensional features comprise embeddings produced by a frozen self-supervised transformer vision backbone and arranged into a sparse voxel representation via geometric projection and multi-view fusion when multiple images are available.

3. The method of claim 1, wherein the sparse voxel representation is stored as a sparse octree or sparse grid and serialized by a space-filling curve order with positional embeddings for attention operations.

4. The method of claim 1, wherein the rectified-flow generative model learns a time-conditioned vector field by conditional flow matching, and inference executes a fixed number of sampling steps to produce the volumetric latent.

5. The method of claim 1, wherein low-rank adapter modules are selectively activated or merged at inference according to a domain profile, and are applied to query, key, and value projection matrices within attention blocks of the rectified-flow generative model.

6. The method of claim 1, wherein the continuous implicit surface function is a signed distance function, and training signals for the decoding include at least one of silhouette consistency, surface-normal alignment, smoothness regularization, and shaded-render photometric comparison.

7. The method of claim 1, wherein the inverse rendering performs registration-aware warping between reference images and differentiable renders of the mesh, and optimizes UV-space maps selected from albedo, normal, roughness, and metalness, while geometry and pose remain fixed.

8. The method of claim 1, further comprising building and maintaining a curated dataset of three-dimensional exemplars in which each exemplar is normalized to a canonical coordinate frame and unit scale, rendered by deterministic camera schedules with known intrinsics and extrinsics to produce multi-modal supervision including at least RGB, linearized depth, surface normals, and silhouettes, and the dataset includes quality-control gates that reject samples exhibiting at least one of silhouette inconsistency, surface-normal instability, or scale outliers, and carries category taxonomy, license identifiers, cryptographic content hashes, and dataset versioning.

9. The method of claim 1, wherein preprocessing includes foreground segmentation to obtain a silhouette mask and optionally monocular depth or surface-normal estimates to stabilize the render-and-compare alignment of step (e).

10. The method of claim 1, further comprising a training procedure that:
(a) extracts per-view features using a frozen self-supervised vision backbone and projects and fuses the features into structured-latent targets comprising sparse, feature-augmented volumetric lattices; and
(b) trains two transformer-based rectified-flow models by conditional flow matching, a first that transports noise to structure latents from noisy voxel inputs conditioned on image features, and a second that transports noise to the volumetric latent decoded by steps (d)(1)-(d)(3), while training the decoders of steps (d)(1)-(d)(3) against multi-modal supervision rendered from three-dimensional exemplars under known camera models, and optionally training low-rank adapter modules on dataset-defined domain slices for activation or merge at inference.

11. A system for producing a three-dimensional digital representation of a target object from at least one two-dimensional input image, the system comprising at least one processor and at least one memory storing instructions that, when executed, cause the system to perform the method of:
(a) receiving the at least one input image;
(b) conditioning a generative model using image-derived, voxelized three-dimensional features;
(c) generating, by a transformer-based rectified-flow generative model parameterized as a base network optionally coupled to one or more low-rank adapter modules activatable at inference, a volumetric latent of the target object, the volumetric latent comprising a sparse, feature-augmented volumetric lattice obtained by transporting an initial random sample toward a learned manifold via a rectified-flow sampling process;
(d) decoding the volumetric latent by:
(1) mapping the volumetric latent to a feature-bearing sparse volumetric field consistent with said volumetric lattice;
(2) decoding the field to a continuous implicit surface function; and
(3) extracting a watertight mesh by isosurface extraction;
(e) estimating camera-pose parameters by iterative render-and-compare alignment between silhouettes rendered from the mesh and silhouettes of the at least one input image; and
(f) performing style-preserving inverse rendering on the mesh that updates UV-space albedo and material maps while keeping mesh geometry and the estimated camera-pose parameters fixed, wherein the method performs images-only inference without reliance on natural-language prompts.

12. A non-transitory computer-readable storage medium storing instructions that, when executed by one or more processors, cause performance of a method of producing a three-dimensional digital representation of a target object from at least one two-dimensional input image, the method comprising:
(a) receiving the at least one input image;
(b) conditioning a generative model using image-derived, voxelized three-dimensional features;
(c) generating, by a transformer-based rectified-flow generative model parameterized as a base network optionally coupled to one or more low-rank adapter modules activatable at inference, a volumetric latent of the target object, the volumetric latent comprising a sparse, feature-augmented volumetric lattice obtained by transporting an initial random sample toward a learned manifold via a rectified-flow sampling process;
(d) decoding the volumetric latent by:
(1) mapping the volumetric latent to a feature-bearing sparse volumetric field consistent with said volumetric lattice;
(2) decoding the field to a continuous implicit surface function; and
(3) extracting a watertight mesh by isosurface extraction;
(e) estimating camera-pose parameters by iterative render-and-compare alignment between silhouettes rendered from the mesh and silhouettes of the at least one input image; and
(f) performing style-preserving inverse rendering on the mesh that updates UV-space albedo and material maps while keeping mesh geometry and the estimated camera-pose parameters fixed. wherein the method performs images-only inference without reliance on natural-language prompts.
